(19) United States
(12) Patent Application Publication
(10) Pub. No.: US 2005/0050108 A1
(43) Pub. Date: Mar. 3, 2005

(54) FILE SYSTEM FOR DIGITAL PROCESSING SYSTEMS WITH LIMITED RESOURCES

(75) Inventors: Anand Shridhar SAWANT, Bangalore (IN); Vinay SRINIVAS, Mysore (IN); New Melchizedec SUNDERARAJ, Chennai (IN)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 10/710,998

(22) Filed: Aug. 16, 2004

Related U.S. Application Data
(60) Provisional application No. 60/496,733, filed on Aug. 21, 2003.

(51) Int. Cl. G06F 7/00

(52) U.S. Cl. 707/200

(57) ABSTRACT

The cluster identifiers of the clusters which together store the data of a file, are retrieved and stored in a random access memory (RAM) according to a pre-specified convention (e.g., as an associative array starting at a pre-specified location of the RAM). Due to such storing, any portion of the content of the file can be accessed quickly. The feature can be advantageously used to reduce memory space requirements. In one embodiment, a metadata processing module retrieves and stores the cluster identifiers, and other modules use the same to access the file contents according to the convention. Thus, such other modules can be implemented with fewer instructions. In addition, each of the other modules can be overlaid in the same memory space used by the metadata processing module, thereby reducing the aggregate memory space requirement.

### CROSS REFERENCE TO RELATED APPLICATIONS

The present application is related to and claims priority from co-pending U.S. provisional patent application entitled, “Pico File System for Embedded Applications”, Filed on: Aug. 21, 2003, Ser. No. 60/496,733, Attorney Docket Number: TI-36864PS, naming as inventors: Sawant et al, and is incorporated in its entirety herewith into the present application.

### BACKGROUND OF INVENTION

1. Field of the Invention

The present invention relates to digital processing systems, and more specifically to a file system suitable for such systems with limited resources (e.g., memory, processing power etc).

2. Related Art

Digital processing systems generally refer to systems processing information in digital format like bits. Examples of digital processing systems include, but not limited to, computers, video/audio players, wireless phones, personal digital assistants (PDAs) etc.

File systems are often supported by digital processing systems. A typical file system contains data stored on a non-volatile memory (e.g., hard drive, CD-ROM, SD Card) according to pre-specified conventions. The conventions may specify the manner in which files (formed from corresponding data) and directories (which hold files and directories) are stored on a non-volatile memory.

In general, file systems store each file/directory using units of storage, which are referred to as clusters. Thus, each file/directory may be stored using one or more clusters. Each cluster may be identified by a corresponding cluster identifier. The cluster identifiers are used to locate the data related to the corresponding files/directories.

Accordingly, a table may be maintained which indicates the cluster identifiers of specific clusters in which the data related to each file/directory is stored. Such tables are often referred to as file allocation tables (FAT) in various known environments.

In general, operations (e.g., read, write, delete) on each file/directory require access to the FAT. As may be appreciated, resources such as memory space (e.g., in a random access memory), processing cycles (e.g., to retrieve, examine, modify, store, etc.) are generally required to perform such operations.

A prior system described in U.S. Pat. No. 6,567,887 entitled “Buffering of partition tables, file system directory structures and individual file cluster chains in a mass storage device”, issued on May 20, 2003 to Tracy Harmer, may store the entire FAT table (in addition to the partition table and the file system directory structures) in a random access memory (RAM) while performing various operations on a file.

Unfortunately, not all systems may have large RAMs to support such storage requirements, and accordingly such a solution may not be acceptable in several environments. Examples of such systems include embedded systems, which are characterized by limited memory, processing power, etc.

In another prior system, cluster identifiers of all the clusters that together store the data of a file of interest are stored in the form of a linked list, and are accessed sequentially traversing the linked list. Such sequential traversal of linked lists may require substantial time and/or processing, thereby making the corresponding solutions also inadequate.

Furthermore, in devices such as audio/video players, sequential (uni-directional) traversal of singly linked lists of cluster identifiers may be unacceptable given the general need to play the signal quickly. As an illustration, assuming a user ‘rewinds’ a song, it may be necessary to access the data from a previous cluster. Since the cluster identifier stored in a FAT entry only points to the next cluster and not to the previous cluster in the cluster chain, the FAT may need to be traversed sequentially from the cluster identifier of the starting cluster of the song/file to determine the previous cluster. The resulting time lag may cause the song to be ‘paused’, which may be undesirable. What is therefore needed is a method and apparatus, which enables digital processing systems with limited resources to operate with such file systems.

### BRIEF DESCRIPTION OF DRAWINGS

The present invention will be described with reference to the accompanying drawings, wherein:

FIG. 1 is a block diagram illustrating the details of an example digital processing system with limited resources.

FIG. 2 is a diagram illustrating the organization of a file system according to one prior approach.

FIG. 3 is a flow chart illustrating a method to extract and store the cluster identifier sequence of a file in accordance with the present invention.

FIG. 4 is a diagram of an array that stores the cluster identifier sequence of a file of interest.

FIG. 5 is a flow chart illustrating a method using which data from the secondary storage can be accessed quickly in an embodiment of the present invention.

FIG. 6 is a block diagram illustrating the organization of memory space in secure RAM in an embodiment of the present invention.

FIG. 7 is a flow chart illustrating the manner in which modules requiring access to a file system can be implemented using reduced memory space.

### DETAILED DESCRIPTION

### 1. OVERVIEW

According to an aspect of the present invention, the cluster identifier sequence (the cluster identifiers of the sequence of clusters that together store the data of a file of interest) of the file of interest is retrieved and stored in a memory (e.g., random access memory). The cluster identifier sequence can be stored using any technique which allows each cluster identifier of this stored sequence to be accessed with less number of (fewer) instructions than the number of instructions required for accessing the same cluster identifier (e.g., from FAT) stored on a disk (or secondary storage, in general).

Due to such storing of the cluster identifiers related to only the file(s) of interest, a system according to an aspect of the present invention may be implemented with a smaller memory space compared to systems using the techniques of U.S. Pat. No. 6,567,887 noted in Related Art section above.

In one embodiment, the cluster identifier sequence is stored in the form of an array, from which each cluster identifier can be accessed in a single access by use of an appropriate index.

Such an approach enables the cluster identifier of the desired cluster (cluster containing the desired data), to be determined quickly (with fewer instructions).

Further, extracting the cluster identifier sequence and storing it in an associative array (a collection of items that are randomly accessible by a key) in RAM type memories may eliminate the need to traverse the cluster identifier linked list of the file of interest in FAT (stored either on disk or in memory) every time any random cluster identifier is required. This also enables faster and easier access to locations within the file.

The memory requirements may also be minimized since only the cluster identifiers of interest (not the entire FAT) can be stored in the memory. As a result, various aspects of the present invention may be suitable for implementation in digital processing systems having limited resources.

Another aspect of the present invention enables applications to be implemented using only a limited amount of memory. A metadata processing module may be provided which retrieves the cluster identifier sequence of the file of interest and stores it using any technique (e.g. in an associative array) as noted above, according to a pre-determined convention (e.g., starting at a pre-specified location). Other data processing modules (implementing the logic of the applications) may access the file content (or perform other operations) by accessing the cluster identifiers directly from the stored location according to the convention. These other data processing modules may be overlaid in the same memory space in which the metadata processing module may be executed, thereby decreasing the aggregate memory space requirements.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the invention.

### 2. EXAMPLE ENVIRONMENT

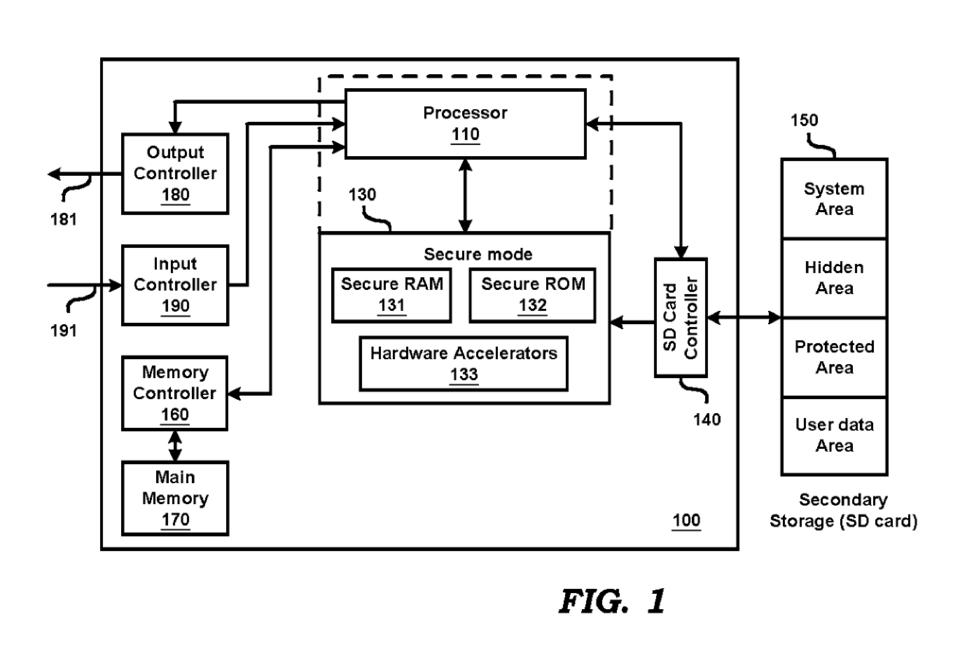

FIG. 1 is a block diagram of a digital processing system 100 in which several aspects of the present invention can be implemented. The system 100 represents an audio player (potentially part of another device such as a cell phone or a personal digital assistant), which can play various songs stored on a secure digital (SD) card 150. Digital processing system 100 is shown containing processor 110, secure mode component 130, SD card controller 140, memory controller 160, main memory 170, output controller 180, and input controller 190. The components of digital processing system 100 are described after describing SD card 150 below.

SD card 150 is shown containing four portions—user data area, protected area, hidden area and system area. The user data area stores data representing several songs in encrypted format. Merely for illustration, the embodiments are described with reference to a device which plays songs. However, several aspects of the present invention can be implemented in the context of other types of data (e.g., multi-media, video, graphics etc.).

The protected area stores various keys necessary for decrypting thesongsstored in the user data area. Both, the user data area and the protected area, use FAT based file systems to store the data. The encryption/decryption mechanism is not described in detail, as not being necessary to understand the various features of the present invention.

The system area may contain data needed to generate certain keys. These keys are used by the program accessing the protected area to communicate with SD card 150 as well as to encrypt and decrypt the data stored in the protected area. The hidden area contains some important keys that are used by the SD card internally.

Secure mode component 130 is shown containing secure RAM (random access memory) 131, secure ROM (read only memory) 132 and hardware accelerators 133. Secure ROM 132 may contain programs required to enter and exit secure mode as well as programs required to provide other utility functions in secure mode. Hardware accelerators 133 provide hardware blocks that generally speed up some of the encryption, decryption and other cryptography related operations.

Secure RAM 131 may contain the program to be executed in secure mode (e.g. the program accessing protected area of the SD card) as well as the data to be processed in secure mode (e.g., the protected area data to be sent to or received from the SD card controller). When secure mode is active, processor 110 is also a part of the secure mode component 130. In FIG. 1, this is represented by a dotted extension of 130.

The manner in which the songs stored in the user data area may be accessed by digital processing system 100 is described below in further detail.

Output controller 180 generates the appropriate electrical signals on path 181 to cause an output device (e.g., speaker, not shown) to play the corresponding audible signals. Input controller 190 receives various commands (e.g., rewind, play, increase volume) from an input device, and passes data representing the commands to processor 110.

Processor 110 may execute various instructions stored in main memory 170, secure RAM 131 and secure ROM 132 to enable a user to play various songs stored on SD card 150. It may also use the hardware accelerators 133 to speed up certain processing. Instructions and data to be executed in non-secure mode may be accessed and processed from main memory 170, while data and instructions to be executed in secure mode may be accessed and processed from secure mode components 130 only. The SD card controller 140 can be accessed in secure as well as non-secure mode.

Typically, the program accessing the protected area of the SD card runs in secure mode while the program accessing the user data area runs in non-secure mode. Both programs send their requests to SD card controller 140 which retrieves the data from SD card 150 and presents to the respective programs. The protected area data coming from (going to) the SD card controller 140 to (from) the program running in secure mode is generally in encrypted format.

The size of secure RAM 131 may be limited/small, for example, due to the constraints posed by manufacturing technologies. In one embodiment, secure RAM 131 contains only 16 KB of memory. Such small memory space may need to support a file system according to which data is stored in the protected area of SD card 150, in addition to the programs processing data from the protected area, programs controlling SD card controller 140 and other utility programs.

An aspect of the present invention enables efficient accesses to the files (songs of the example embodiment) using the limited available memory as described below in further detail. It should be understood that various aspects of the present invention can be implemented with respect to directories even though the examples are described with respect to files.

### 3. EXAMPLE FILE SYSTEM

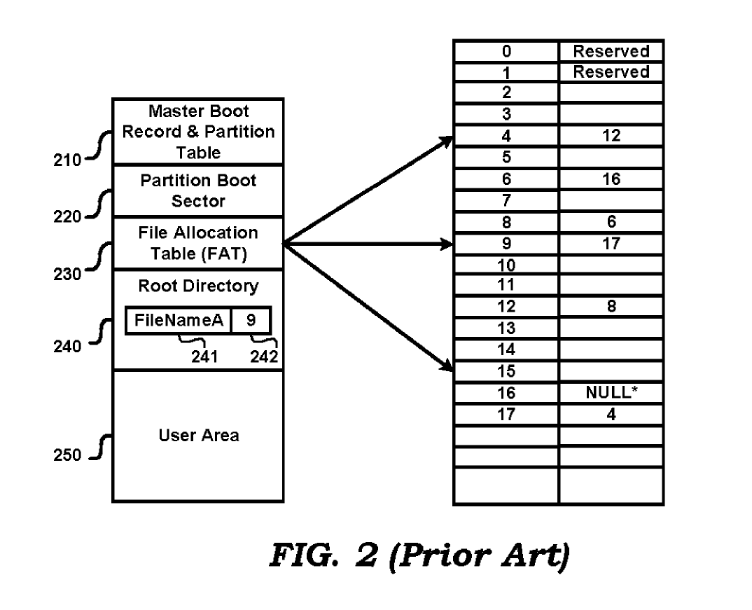

FIG. 2 is a diagram depicting the logical organization of data on an example secondary storage that uses a FAT based file system. Although the secondary storage could be of any form like hard disk, SD card etc., for conciseness, it is referred to as disk. The diagram illustrates the manner in which data related to various files may be organized consistent with the conventions of a FAT based file system. The disk is shown containing master boot record and partition table 210, partition boot sector 220, file allocation table (FAT) 230, root directory 240 and user area 250. Each portion is described below in detail.

Master boot record and partition table 210, which is stored at a fixed location on the disk, may contain data representing system boot information. This information is generally used during initialization to load an operating system (which then controls the operation of the system using the disk). In addition, a partition table indicates the number of partitions supported by the disk and the specific location on the disk where each partition starts. For conciseness, it is assumed that only one partition is present on the disk, and the corresponding partition boot sector is shown by reference number 220 in FIG. 2.

Partition boot sector 220 may contain various pieces of management information such as the number of sectors per cluster, total sectors etc. Each partition may contain a corresponding boot section, in addition to FAT, root directory and user area described in detail below.

User area 250 stores the data related to various files and directories. The entire disk is generally organized in the form of sectors, typically of fixed sized. The sectors in user area 250 may be grouped into clusters. In an embodiment, four sectors are grouped together as one cluster. A cluster is used as a basic unit of allocation for each file. The manner in which storage of files and directories may be supported in clusters is described below.

Root directory 240 may indicate the files/directories in the first level of hierarchy and the cluster identifier of the cluster at which each file/directory starts. The entries in FAT 230 indicate the cluster identifiers (in sequence) of the subsequent clusters storingthe data related to each file/directory.

File allocation table (FAT) 230 may contain a number of entries equal to the number of clusters in that partition. Thus each cluster in the partition is represented by one entry in the FAT. The size of each FAT entry is decided by the FAT type (12 bits for FAT12 and 16 bits for FAT16). The value of each FAT entry indicates one of the following: 1.Unused cluster, available for allocation to a file or directory; 2.Allocated cluster, with the value of the FAT entry giving the cluster identifier of the next cluster that follows the present cluster in a chain of clusters that together store the file or directory;3.Reserved value for future standardization; 4.Defective cluster; and5.Allocated cluster and also the final cluster of the file or directory.

If one considers the FAT entries corresponding to the clusters storing data for a particular file/directory alone, each entry (except the last one which contains a special value) contains the cluster identifier of the next cluster in the chain. Since each cluster is represented by one FAT entry, this cluster identifier also indicates the next FAT entry that needs to be read to determine the cluster identifier of the next to next cluster.

Thus, it may be appreciated that the cluster identifier sequence (related to any file) is represented in the form of a linked list in FAT. In the example of FIG. 2, field 241 (in root directory 240) is shown containing a file name (FileNameA) and field 242 is shown containing the cluster identifier (9) of the first cluster of that file. Entry 9 of FAT 230 contains cluster identifier 17, indicating that cluster 17 is the next cluster in the chain. It also indicates that one should read entry 17 of FAT to find the next to next cluster identifier.

Thus, cluster 9 is linked to cluster 17, then 17 is linked to 4, 4 linked to 12, then cluster 8, then 6, and finally cluster 16 having a value of NULL (in FAT systems, a number in a pre-specified range, e.g., between FF8 to FFF for FAT12 file system and a number between FFF8 to FFFF for FAT16 file system, indicates the end of the cluster chain) representing the end of the cluster chain. Thus the data corresponding to FileNameA is stored in a cluster chain of clusters 9, 17, 4, 12, 8, 6 and 16. Also, the cluster identifier sequence of the file FileNameA is 9, 17, 4, 12, 8, 6, 16.

Accessing desired data may pose several challenges at least in systems with limited resources. For example, with reference to the above example, assuming it is determined that the desired data is in the fifth cluster of the cluster identifier sequence allocated to the file FileNameA, it may be required to access FAT 230 four times to traverse the linked list of (9, 17, 4, 12) before determining that cluster with cluster identifier 8 contains the desired data. As FAT 230 is available on a secondary storage, which generally is accessible with high latencies, the total time to determine the cluster identifier of interest may be unacceptably high.

In one prior approach (noted in the Related Art section above), the entire FAT 230 may be stored in a random access memory, thereby minimizing the amount of time required to determine the desired cluster while traversing a linked list. One problem with such an approach is that the RAM needs to provide substantial memory space since FAT itself may occupy many sectors. In the case of system 100, it may be desirable to store FAT data for protected area in secure RAM 131. Unfortunately, secure RAM may not contain such large space, as noted above. Also, this approach does not eliminate the need to traverse the cluster identifier linked list of the file of interest in FAT (stored in memory), starting from the cluster identifier of the first cluster of that file, every time any random cluster identifier is required.

Further, in case system 100 is potentially part of another device such as a cell phone or a personal digital assistant or a portable music player, the user may need to access only few songs (typically only one) at a time. In such case, considering the limited available memory, there may not be a need to store the entire FAT. However, the FAT entries belonging to the cluster identifier sequence might be spread randomly across the entire FAT. Hence, if one uses the above-noted prior approach, the entire FAT may need to be kept in RAM for efficient operation.

In addition, processing of FAT entries itself may be complicated, especially in case of FAT12. In FAT12, each FAT entry takes 12 bits. Thus, two FAT entries are stored in three bytes with 4 bits of one entry paired with 4 bits of other entry to form a byte. Hence, each attempt to read/write a FAT entry in a FAT12 file system requires some extra processing to extract a 12 bit number from two bytes/to write two bytes for a 12 bit number. Since the above-noted prior approach stores the entire FAT as it is in RAM, one has to still carry out this extra processing on the FAT entries in RAM for each attempt to read/write a FAT entry. And this could lead to more processing power and longer processing times, especially in case of the memory and processing power limited systems like system 100 in FIG. 1.

Also, at least in devices which play music, it is desirable that the desired data be accessed quickly since a user may perform operations such as rewind, jumping to some previous song in the song list, etc. which would require accessing a prior cluster in the cluster identifier sequence. In such a situation, traversal of the cluster identifier linked list starting from the cluster identifier of the first cluster till the cluster identifier of the desired cluster is reached may lead to a pause in playing the song, which is undesirable. It is generally desirable to provide continuity in playing the song without requiring substantial resources. An aspect of the present invention enables one or more of such objectives to be attained, as described below in further detail.

### 4. ACCESSING DESIRED DATA EFFICIENTLY

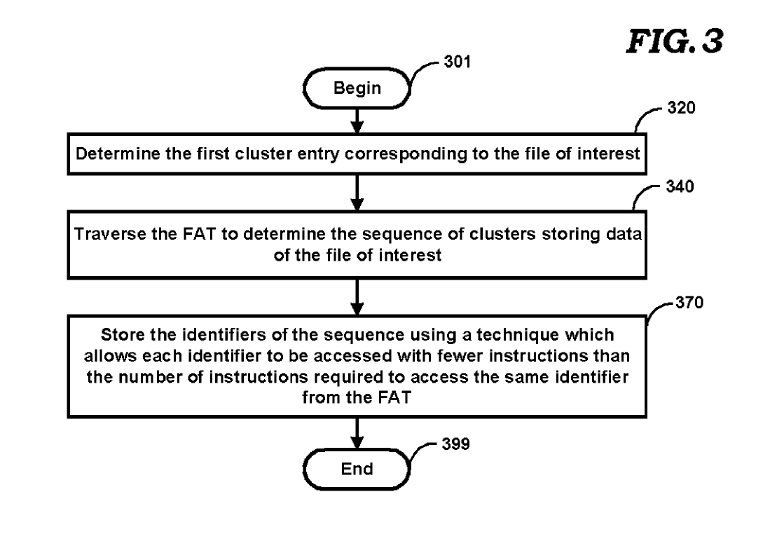

FIG. 3 is a flow chart illustrating the manner in which data corresponding to a file of interest may be accessed efficiently according to an aspect of the present invention. The flow chart is described with reference to FIGS. 1 and 2 merely for illustration; however the corresponding approaches can be implemented in other devices/environments as well, without departing from the scope and spirit of several aspects of the present invention.

In addition, the steps are described as being performed by a program executing in secure mode. The program may be operational (executed) by execution of appropriate instruction by processor 110 contained in the system of FIG. 1. The flow chart starts in step 301, in which control immediately passes to step 320.

In step 320, a program executing/running in secure mode may determine the cluster identifier of the first cluster of the file of interest. Such a determination may be performed by accessing root directory 240 and subdirectories, if any.

In step 340, the program running in secure mode traverses FAT 230 to determine the sequence of clusters that together store the data of the file of interest. As each cluster is identified by a cluster identifier, corresponding cluster identifier sequence is determined. The determination requires multiple accesses to FAT 230 (at least given the linked list organization in the described embodiments). With respect to file ‘FileNameA’ of FIG. 2, the cluster identifier sequence contains 9, 17, 4, 12, 8, 6, and 16.

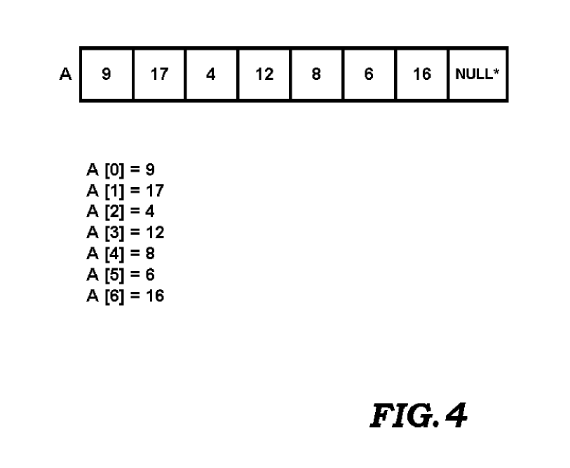

In step 370, the program running in secure mode stores the cluster identifier sequence using a technique which allows each identifier of this stored sequence to be accessed with fewer instructions than the number of instructions required to access the same identifier from the FAT. One example of such technique is storing the cluster identifier sequence in an associative array in a memory (RAM), as illustrated with reference to FIG. 4.

As may be appreciated, each cluster identifier can be accessed randomly by a corresponding index of/to the array, and thus the array forms an associative array. However other approaches such as rehashing techniques (e.g., Java Vector) can also be used to store the cluster identifiers. Also, if the cluster identifier sequence is very big, then only that part of the cluster identifier sequence which is/may be required for the current/future file content processing can be kept in the array. The method of FIG. 3 ends in step 399.

In one embodiment, the program running in secure mode stores the cluster identifier sequence in an array in secure RAM 131, with each array entry storing one cluster identifier (as depicted in FIG. 4). Next, knowing the start offset of the data to be accessed and number of bytes per cluster, the cluster index of the desired cluster in the cluster identifier sequence is computed. Then, in the embodiment noted above (using associative array), any cluster identifier can be accessed in one memory access by using the computed cluster index as the key. However, depending on the word length of the RAM, multiple cluster identifiers may be packed into a single memory location or each cluster identifier can be stored in a single location.

Since the entire cluster identifier sequence of the file/directory of interest is extracted and maintained in memory, there may not be a need to keep the entire FAT in memory. This generally saves substantial amount of memory space.

Further, for FAT12 as well as FAT16 file system, each cluster identifier in the cluster identifier sequence may be stored as a 16 bit number. In case of FAT12, leading zeros may be added to convert the 12 bit FAT entry into a 16 bit cluster identifier. This eliminates the need for extra processing (to extract a 12 bit number from two bytes/to write two bytes for a 12 bit number) for each FAT12 entry read/write operation.

Finally, since such storing of cluster identifiers in memory (or other efficient access mechanisms) allows any cluster identifier of the stored cluster identifier sequence to be accessed with less number of accesses (which translates to instructions and time), operations such as rewind may not lead to a pause while playing the song.

These advantages are often important for the memory and processing power limited systems like system 100 in FIG. 1. The description is continued with respect to the manner in which operations on the file can be performed efficiently in one embodiment.

### 5. ACCESSING DATA QUICKLY

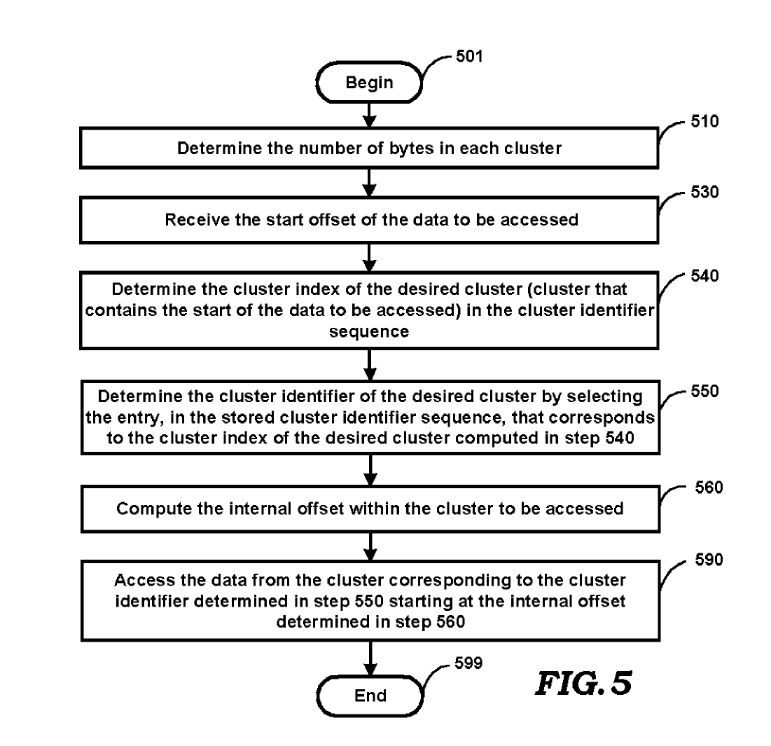

FIG. 5 is a flow chart illustrating the manner in which data from the disk can be accessed quickly in an embodiment of the present invention. The flow chart is described with reference to FIGS. 1 and 2 merely for illustration; however the corresponding approaches can be implemented in other devices/environments as well, without departing from the scope and spirit of several aspects of the present invention. The flow chart starts in step 501, in which control immediately passes to step 510.

In step 510, a program running in secure mode (similar to the example scenario of FIG. 3) may determine the number of bytes in each cluster. In an embodiment, all clusters are of uniform size, and partition boot sector 220 contains the number of sectors per cluster and sector size. From this information, the total number of bytes in a cluster is determined as (sectors per cluster*sector size). For illustration, it is assumed that sectors per cluster=1 and sector size=512 bytes, and accordingly total number of bytes per cluster=1*512.

In step 530, the program running in secure mode receives the start offset of the data to be accessed (offset of the data to be accessed from the start of the file to which it belongs). For illustration, it is assumed that the desired offset equals 2000.

In step 540, the program running in secure mode computes the cluster index of the desired cluster (cluster that contains the start of the data to be accessed) in the cluster identifier sequence by dividing the start offset by the number of bytes per cluster, and rounding off the result to the greatest integer which is less than or equal to the result of the division operation (assuming cluster index starts with 0). In the illustrative example, the cluster index equals 3 since 2000/512=3.90625.

In step 550, the program running in secure mode determines the cluster identifier of the desired cluster by selecting the entry, in the stored cluster identifier sequence, that corresponds to the cluster index of the desired cluster computed in step 540. In the illustrative example, assuming that the cluster identifier sequence is as in FIG. 4, the cluster identifier of the desired cluster is 12 corresponding to the computed cluster index of 3 (as may be observed from FIG. 4, as well).

Assuming that the cluster identifier sequence is stored as an array in memory, in which case the computed cluster index can be used as a key to access the specific entry, the cluster identifier of the desired cluster can be determined in a single access.

In step 560, the program running in secure mode computes the internal offset within the cluster to be accessed. In the illustrative example, the internal offset equals (2000−(3*512))=464.

In step 590, the program running in secure mode issues commands to access the data from the cluster corresponding to the cluster identifier determined in step 550 starting at the internal offset determined in step 560. The method ends in step 599.

From the above, it may be appreciated that the approach of above enables desired data to be accessed quickly. In the case of devices that play songs, such a feature may be useful to quickly access data during a rewind operation which requires access to data from a prior cluster. In the example environment, if the user selects some previous song in the list, the program running in secure mode may need to get the key for that song from the key file in the protected area. Accessing key of a previous song may require accessing a prior cluster of the key file. In this case, the above noted feature may be used since it allows quick access to any location, and hence any key, in the key file. The description is continued with respect to another aspect of the present invention, which enables the memory space in small memories to be used efficiently (while enabling access to a file system). First, an example scenario where such features may be useful is described below.

### 6. EXAMPLE SCENARIO REQUIRING EFFICIENT MEMORY USE

In one embodiment, secure RAM 131 has only 11 KB available for data storage and execution of software instructions performing various file operations (and others). Accordingly, the memory locations may need to be shared by various modules (executing corresponding tasks, also referred to as sub-applications) using techniques such as overlaying, well known in the relevant arts. The system may impose an additional constraint in that one module may not call another module directly.

Due to the limited amount of memory space available in secure RAM 131, it may be desirable to minimize the complexity of implementation of the file system. The features described above that simplify and speed-up the determination of the cluster identifier of the desired cluster may conveniently be used to minimize the complexity as described below.

### 7. SMALLER MODULES

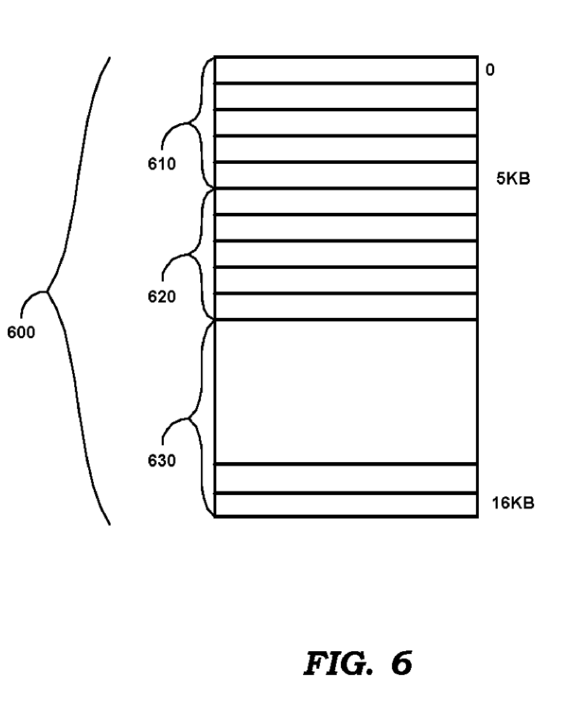

FIG. 6 is a block diagram illustrating the manner in which the memory space in secure RAM 131 may be used to facilitate implementation of smaller modules according to an aspect of the present invention. For illustration, it is assumed that only 16 KB of space is available, and accordingly memory space 600 is shown with only 16 KB. Memory space 600 is shown divided into portions 610, 620 and 630, which are described below in further detail.

Portion 610 is assumed to be reserved for various system operations and could take up to 5 KB, and thus unavailable for various file system operations.

Portion 620 represents a shared buffer into which a module (metadata processing module) stores the cluster identifier sequence, for example, by performing the steps described above with reference to FIG. 3. Any other module operating on the file may then use the data in the shared buffer. Using portion 620 represents an example convention for storing the retrieved cluster identifier sequence.

Portion 630 is available for execution of the metadata processing module, as well as other data processing modules operating on a desired file. These other data processing modules may need to be designed to operate from the data in the shared buffer. As such these other data processing modules may be relieved of the task of traversing the FAT on the disk and retrieving the cluster identifier sequence. Hence, the implementation of these other data processing modules may be simplified, thereby making them smaller in size.

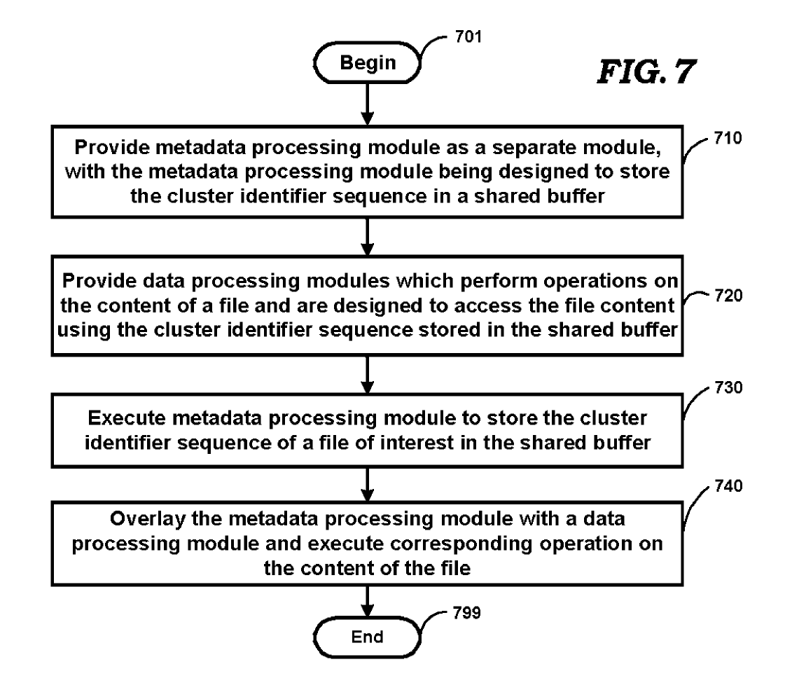

Further, the metadata processing module may be overlaid with other data processing modules in portion 630, thereby decreasing the aggregate memory space requirements. The approach to reduce the module size as well as overlaying them is summarized below with reference to FIG. 7.

FIG. 7 is a flow chart illustrating the manner in which modules requiring access to a file system can be implemented as small modules with a correspondingly small number of instructions. The flow chart is described with reference to FIGS. 1-6 merely for illustration. However, the approaches can be used in other environments as well. The flow chart starts in step 701, in which control passes to step 710.

In step 710, a metadata processing module may be provided as a separate module, with the metadata processing module being designed to determine and store the cluster identifier sequence (corresponding to cluster data of a file of interest) in a shared buffer. The metadata processing module may be implemented using the description provided above with reference to FIGS. 3 and 4.

In an embodiment, the metadata processing module performs operations such as processing the partition table, the master boot record and the partition boot sector and extracting only relevant information (e.g. bytes per cluster) to a shared buffer (partition 620, in the above description). Also, it processes FAT and extracts and stores the cluster identifier sequence of the file(s) of interest in a shared buffer (partition 620, in the above description).

The cluster identifier sequence may be stored as described above with reference to FIGS. 3 and 4. Metadata processing module may also be implemented to update the FAT and creating and updating directories. The metadata processing module may also implement file system operations such as changing directory, creating a directory, creating a file, opening a file, closing a file etc.

In step 720, data processing modules which perform operations on the content of the file(s) of interest are provided as separate modules. They are designed to perform these operations using the cluster identifier sequence stored in the shared buffer. These modules may implement file system operations such as seeking to the desired offset in the file, reading from a file, writing to a file etc.

In step 730, the metadata processing module is executed to extract and store in a shared buffer (e.g., partition 620 in the above description) the relevant file system information and the cluster identifier sequence of the file(s) of interest. If needed, the FAT is updated.

In step 740, the memory space used by the metadata processing module may be used by data processing modules using techniques such as overlay. These data processing modules perform operations on the content of the file(s) of interest using the relevant file system information and the cluster identifier sequence stored in the shared buffer 620. As a result, all the modules can be implemented with reduced number of instructions, and can be executed using limited memory space. The flow chart ends in step 799.

It may be appreciated that various features described above can be provided by execution of appropriate software instructions. The software instructions may be provided from a secondary memory (e.g., hard drive, flash memory, ROM and removable storage drive). The secondary memory may store the data and software instructions, which enable a processor such as processor 110 to provide several features in accordance with the present invention.

Some or all of the data and instructions may be provided on a removable storage provided to processor 110. Floppy drive, magnetic tape drive, CD-ROM drive, DVD Drive, Flash memory, removable memory chip (PCMCIA Card, EPROM) are examples of such removable storage drive.

The removable storage unit may be implemented using medium and storage format compatible with the removable storage drive such that removable storage drive (and thus the processor) can read the data and instructions. Thus, removable storage unit includes a computer readable storage medium having stored therein computer software and/or data.

In this document, the term “computer program product” is used to generally refer to a storage medium such as a removable storage or a hard disk. These computer program products are means for providing software to system 100. Processors may retrieve the software instructions, and execute the instructions to provide various features of the present invention as described above.

### 8. CONCLUSION

While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

1. A method of accessing data contained in a first file, wherein said first file is comprised in a plurality of files stored on a secondary storage, said secondary storage comprising a plurality of clusters, a file allocation table (FAT) indicating a corresponding set of clusters allocated to each of said plurality of files, said method comprising:
determining a set of identifiers, wherein each of said set of identifiers identifies a corresponding one of said set of clusters allocated to said first file; and
storing said set of identifiers in a random access memory (RAM),
wherein storing said set of identifiers in said RAM enables faster access to data related to said first file, and not having to store said entire FAT in said RAM minimizes memory space requirements in said RAM.

2. The method of claim 1, wherein each of said plurality of clusters is identified by a corresponding one of a plurality of identifiers, said FAT storing each of said sets of identifiers in the form of a linked list, wherein an order specified by said linked list indicates the sequence in which said set of clusters are used to store data contained in said first file, said method comprising:
traversing said linked list to retrieve said set of identifiers in said order,wherein said storing stores said set of identifiers in said RAM.

3. The method of claim 2, wherein said set of identifiers are stored according to a technique by which each of said set of identifiers can be retrieved with fewer instructions than the number of instructions required to access the same identifier from said FAT in said secondary storage.

4. The method of claim 2, wherein said set of identifiers are stored in the form of an array from which each identifier can be retrieved by a single access.

5. The method of claim 4, further comprising:
receiving a start offset of data to be accessed;
computing a cluster index by dividing said start offset by a number of bytes in each of said plurality of clusters; and
accessing said array using said cluster index to determine a specific one of said set of identifiers, wherein said data to be accessed is present in a cluster identified by said specific one of said set of identifiers.

6. The method of claim 5, wherein data stored in said file represents a song.

7. A method of implementing an application in a system containing a small memory, wherein said system supports a file system on a secondary storage, wherein said secondary storage comprises a plurality of clusters, wherein said file system comprises a plurality of files and each of said plurality of files is stored in a corresponding one of a plurality of sets of clusters, said plurality of sets of clusters being contained in said plurality of clusters, said method comprising:
providing a first module which is designed to determine a plurality of identifiers corresponding to a specified file and store said plurality of identifiers according to a convention, wherein said plurality of identifiers specify a set of clusters corresponding to said specified file, said set of clusters being contained in said plurality of sets of clusters;
providing a second module which is to perform an operation on a file of interest, wherein said second module is designed to determine a desired cluster by using said plurality of identifiers stored according to said convention;
executing said first module while specifying said file of interest as said specified file such that a plurality of identifiers corresponding to said file of interest are stored according to said convention; and
executing said second module after executing said first module,
wherein both of said first module and said second module are executed using at least some of the same locations of said small memory.

8. The method of claim 7, wherein said second module is overlaid on the same memory space on which said first module is loaded during execution.

9. The method of claim 8, wherein said convention comprises storing said plurality of identifiers at a prespecified portion of RAM.

10. The method of claim 9, wherein each of said plurality of files stores data representing a corresponding song.

11. A machine readable medium carrying one or more sequences of instructions for causing a digital processing system to access data contained in a first file, wherein said first file is comprised in a plurality of files stored on a secondary storage, said secondary storage comprising a plurality of clusters, a file allocation table (FAT) indicating a corresponding set of clusters allocated to each of said plurality of files, wherein execution of said one or more sequences of instructions by one or more processors contained in said digital processing system causes said one or more processors to perform the actions of:
determining a set of identifiers, wherein each of said set of identifiers identifies a corresponding one of said set of clusters allocated to said first file; and
storing said set of identifiers in a random access memory (RAM),
wherein storing said set of identifiers in said RAM enables faster access to data related to said first file, and not having to store said entire FAT in said RAM minimizes memory space requirements in said RAM.

12. The machine readable medium of claim 11, wherein each of said plurality of clusters is identified by a corresponding one of a plurality of identifiers, said FAT storing each of said sets of identifiers in the form of a linked list, wherein an order specified by said linked list indicates the sequence in which said set of clusters are used to store data contained in said first file, further comprising:
traversing said linked list to retrieve said set of identifiers in said order, wherein said storing stores said set of identifiers in said RAM.

13. The machine readable medium of claim 12, wherein said set of identifiers are stored according to a technique by which each of said set of identifiers can be retrieved with fewer instructions than the number of instructions required to access the same identifier from said FAT in said secondary storage.

14. The machine readable medium of claim 12, wherein said set of identifiers are stored in the form of an array from which each identifier can be retrieved by a single access.

15. The machine readable medium of claim 14, wherein said array comprises an associative array.

16. The machine readable medium of claim 14, further comprising:
receiving a start offset of data to be accessed;
computing a cluster index by dividing said start offset by a number of bytes in each of said plurality of clusters; and
accessing said array using said cluster index to determine a specific one of said set of identifiers, wherein said data to be accessed is present in a cluster identified by said specific one of said set of identifiers.

17. A machine readable medium carrying one or more sequences of instructions for causing a digital processing system to implement an application using a small memory space, wherein said digital processing system supports a file system on a secondary storage, wherein said secondary storage comprises a plurality of clusters, wherein said file system comprises a plurality of files and each of said plurality of files is stored in a corresponding one of a plurality of sets of clusters, said plurality of sets of clusters being contained in said plurality of clusters, wherein execution of said one or more sequences of instructions by one or more processors contained in said digital processing system causes said one or more processors to perform the actions of:
providing a first module which is designed to determine a plurality of identifiers corresponding to a specified file and store said plurality of identifiers according to a convention, wherein said plurality of identifiers specify a set of clusters corresponding to said specified file, said set of clusters being contained in said plurality of sets of clusters;
providing a second module which is to perform an operation on a file of interest, wherein said second module is designed to determine a desired cluster by using said plurality of identifiers stored according to said convention;
executing said first module while specifying said file of interest as said specified file such that a plurality of identifiers corresponding to said file of interest are stored according to said convention; and
executing said second module after executing said first module,
wherein both of said first module and said second module are executed using at least some of the same locations of said small memory.

18. The machine readable medium of claim 17, wherein said second module is overlaid on the same memory space on which said first module is loaded during execution.

19. The machine readable medium of claim 18, wherein said convention comprises storing said plurality of identifiers at a pre-specified portion of a RAM.

20. An apparatus accessing data contained in a first file, wherein said first file is comprised in a plurality of files stored on a secondary storage, said secondary storage comprising a plurality of clusters, a file allocation table (FAT) indicating a corresponding set of clusters allocated to each of said plurality of files, said apparatus comprising:
means for determining a set of identifiers, wherein each of said set of identifiers identifies a corresponding one of said set of clusters allocated to said first file; and
means for storing said set of identifiers in a random access memory (RAM),
wherein storing said set of identifiers in said RAM enables faster access to data related to said first file, and not having to store said entire FAT in said RAM minimizes memory space requirements in said RAM.

21. The apparatus of claim 20, wherein each of said plurality of clusters is identified by a corresponding one of a plurality of identifiers, said FAT storing each of said sets of identifiers in the form of a linked list, wherein an order specified by said linked list indicates the sequence in which said set of clusters are used to store data contained in said first file, said apparatus further comprising:
means for traversing said linked list to retrieve said set of identifiers in said order,wherein said storing stores said set of identifiers in said RAM.

22. The apparatus of claim 21, wherein said set of identifiers are stored according to a technique by which each of said set of identifiers can be retrieved with fewer instructions than the number of instructions required to access the same identifier from said FAT in said secondary storage.

23. The apparatus of claim 21, wherein said set of identifiers are stored in the form of an array from which each identifier can be retrieved by a single access.

24. The apparatus of claim 23, wherein said array comprises an associative array.

25. The apparatus of claim 24, further comprising:
means for receiving a start offset of data to be accessed;
means for computing a cluster index by dividing said start offset by a number of bytes in each of said plurality of clusters; and
means for accessing said array using said cluster index to determine a specific one of said set of identifiers,
wherein said data to be accessed is present in a cluster identified by said specific one of said set of identifiers.

26. An apparatus implementing an application in a system containing a small memory, wherein said system supports a file system on a secondary storage, wherein said secondary storage comprises a plurality of clusters, wherein said file system comprises a plurality of files and each of said plurality of files is stored in a corresponding one of a plurality of sets of clusters, said plurality of sets of clusters being contained in said plurality of clusters, said apparatus comprising:
providing a first module which is designed to determine a plurality of identifiers corresponding to a specified file and store said plurality of identifiers according to a convention, wherein said plurality of identifiers specify a set of clusters corresponding to said specified file, said set of clusters being contained in said plurality of sets of clusters;
providing a second module which is to perform an operation on a file of interest, wherein said second module is designed to determine a desired cluster by using said plurality of identifiers stored according to said convention;
executing said first module while specifying said file of interest as said specified file such that a plurality of identifiers corresponding to the clusters of said file of interest are stored according to said convention; and
executing said second module after executing said first module,
wherein both of said first module and said second module are executed using at least some of the same locations of said small memory.

27. The apparatus of claim 26, wherein said second module is overlaid on the same memory space on which said first module is loaded during execution.

28. The apparatus of claim 27, wherein said convention comprises storing said plurality of identifiers at a pre-specified portion of a RAM.
